(19) United States
(12) Patent Application Publication
(10) Pub. No.: US 2005/0016259 A1
(43) Pub. Date: Jan. 27, 2005

(54) Variable function voting solenoid-operated valve apparatus having air-to-move valve actuators and testing method therefor

(76) Inventors: Bryan A. Zachary, Alvin, TX (US); Angela E. Summers, Houston, TX (US)

Correspondence Address: Arnold & Ferrera, L.L.P.;Suite 630, 2401 Fountain View Dr., Houston, TX, 77057, US

(21) Appl. No.: 10/828,361

(22) Filed: Apr. 20, 2004

Related U.S. Application Data
(63) Continuation-in-part of application No. 09/756,844, filed on Jan. 9, 2001, now Pat. No. 6,722,383.
(63) Continuation-in-part of application No. 10/663,588, filed on Sep. 17, 2003.

(51) Int. Cl. E03B 1/00; F17D 1/00; F17D 3/00; G01M 3/02

(52) U.S. Cl. 73/37

(57) ABSTRACT

A variable function voting solenoid-operated valve apparatus is provided having both high safety availability and high plant reliability that does not require a plant system to be bypassed during testing. Also provided is a variable function voting solenoid-operated valve apparatus wherein initiation of a safety action will occur only if each of a pair of operatively associated solenoid-operated valves in the apparatus are actuated, and wherein either of the solenoid valves can singly default to a pre-designated safety action without inadvertently actuating the process valve and isolating or venting the process fluid. Also provided is a variable function voting solenoid-operated valve apparatus, wherein a plurality of pressure sensing devices are incorporated to detect failure of either of a pair of operatively associated solenoid-operated valves so as to prevent inadvertent initiation of a safety action, and wherein a bypass switch is provided to allow on-line maintenance of the device should one of the solenoid valves fail during operation or when a failure is detected during a testing cycle. Finally, a variable function voting solenoid-operated valve apparatus is provided, wherein diagnostic information on the performance of the safety action, a partial movement of the process valve can be executed to prove the process valve is capable of actuating to the safe state, can be ascertained with either operational mode using a logic control system depending on the technical requirements of a given plant environment.

### CROSS-REFERENCE TO RELATED APPLICATIONS

The present application is a continuation in part of prior applications Ser. Nos. 09/756,844 and 10/663,588, each of which are entitled Variable Function Voting Solenoid-Operated Valve Apparatus and Testing Method Therefor.

### BACKGROUND OF THE INVENTION

1. Field of the Invention

The present invention relates generally to voting solenoid-operated valve devices for testing and controlling industrial process systems, and more particularly to a variable function voting solenoid-operated valve apparatus employing air to move fail last position actuators to direct the flow of a fluid media in a processing or manufacturing plant.

2. Background of the Invention

Modern process or manufacturing plants consist of innumerable individual components. These components are integrated to form operational systems controlled by instrumentation and control systems consisting of a variety of sensors and controllers. The operational and control systems serve not only to achieve desired process conditions and parameters, but also to allow a plant facility to safely modify or discontinue operation of all or a portion of the plant's systems and components in order to avoid development of a predetermined deleterious safety condition.

For example, control systems typically require that a process valve be taken off line prior to initiation of routine testing and maintenance in order to verify that the valve is performing properly. From both an operational and economic standpoint, however, it is highly desirable that such systems or configurations should not unnecessarily modify or discontinue operation of the process valves being monitored.

One manner in which such systems operate is by isolating or venting certain process fluids when an unsafe operating condition has been detected by the safety system. Depending on the particular processing or manufacturing plant's intended operational parameters, this isolation and/or venting of process fluids can be accomplished by actuating one or more process valves. For example, a pneumatic fluid supply can be directed toward a process valve actuator through the use of a single solenoid-operated valve to vent process pressure when a predetermined safety condition has been detected.

In function, the solenoid-operated valves of such safety systems or configurations serve to initiate a process whereby a fluid or pneumatic supply is applied to one side of the actuator while venting pressure on the other side of the actuator when the operatively associated solenoid-operated valve changes state or position in a predetermined manner, e.g., when the solenoid-operated valve is de-energized by an associated logic control system. The plant processing system and any subservient system or component controlled thereby is then placed in an operational configuration pre-designated as a “safety action”.

It is frequently the case that testing and maintenance of an individual solenoid valve should be accomplished without initiating the safety action, thereby avoiding an undesired modification or discontinuance of the plant process system being monitored. However, single solenoid valve configurations have in the past necessarily required a trade-off by operators between either discontinuing safety monitoring during testing and maintenance or risking false initiations of the safety action as a result of limited or incomplete testing and maintenance.

For example, a “1 out of 1” solenoid-operated valve configuration is previously known in which a single solenoid-operated valve is employed for activating the system's safety action by actuating process valves upon detection of an unsafe condition. Such configurations can achieve high plant safety availability when solenoid-operated valve operation is regularly tested by de-energizing the solenoid-operated valve and then monitoring a venting of the fluid or pneumatic supply through an exhaust body such as an anodized aluminum or composite material manifold or the like. Since the process valve and ultimately the plant process system (or its constituent components) may be affected by such venting, testing of the solenoid-operated valve can only be performed under plant bypass conditions, wherein the fluid or pneumatic supply is allowed to pass directly to one side of the process valve actuator while venting pressure on the other side of the actuator by means of a bypass valve. When the solenoid-operated valve is bypassed for testing, the safety action (actuation of the process valve) intended to avoid the unsafe condition cannot be initiated by the solenoid-operated valve.

In practice, the overall safety availability performance of a 1 out of 1 solenoid-operated valve is therefore limited by the percentage of operational time required in a bypass state for testing and maintenance. Moreover, such configurations can achieve only relatively low plant system reliability outside of testing and routine maintenance, since an unexpected component failure within the solenoid-operated valve, for example, a coil failure, will necessarily cause an inadvertent venting or isolation of the fluid or pneumatic supply, i.e., actuation of the process valve and initiation of the safety action.

3. Objects of the Invention

In view of the foregoing, an object of the present invention is to provide a variable function voting solenoid-operated valve apparatus having both a high safety availability and high plant system reliability that does not require a plant system to be bypassed during testing and maintenance. A further object of the invention is to provide a variable function voting solenoid-operated valve apparatus wherein actuation of the process valve and isolation or venting of the process fluid will occur only if both solenoid-operated valves in a system are actuated, and wherein either of the solenoid-operated valves can default to the safety action without inadvertently actuating the process valve and isolating or venting the process fluid. A still further object of the invention is to provide a variable function voting solenoid-operated valve apparatus wherein a plurality of pressure sensing devices are incorporated to detect failure of either of a pair of operatively associated solenoid-operated valves so as to prevent inadvertent initiation of a safety action, and wherein a bypass valve is provided to allow on-line maintenance of the device should one of the solenoid-operated valves or pressure sensing devices fail during operation or when a failure is detected during a testing cycle. A still further object of the invention is to provide a means to partially initiate the safety action, without undesired modification or disruption of the plant process system being monitored, providing diagnostic information on the safety action.

### BRIEF SUMMARY OF THE INVENTION

According to one aspect of the present invention, a variable function voting solenoid-operated valve apparatus useful for testing and controlling industrial process systems by actuating process valves is provided wherein the apparatus comprises a first solenoid-operated valve and a second solenoid-operated valve; a bypass valve; and a plurality of pressure sensing devices including a first pressure sensor in fluid communication with said first solenoid-operated valve, a second pressure sensor in fluid communication with said second solenoid-operated valve, and a third pressure sensor in fluid communication with said bypass valve.

In a presently preferred embodiment of the invention, a variable function voting solenoid-operated valve apparatus is provided comprising a first solenoid-operated valve and a second solenoid-operated valve, wherein actuation of the process valve and therefore the safety action is provided by means of a pneumatic supply to actuate the process valve being directed by the solenoid-operated valve apparatus, and electrical control of said first and second solenoid-operated valves is provided by means of a logic control system or processor; a bypass valve actuated by a key-switch; a valve manifold, wherein said first and second solenoid-operated valves and said bypass valve are joined by said valve manifold; and a plurality of pressure switches including a first pressure switch in fluid communication with said first solenoid-operated valve, a second pressure switch in fluid communication with said second solenoid-operated valve, and a third pressure switch in fluid communication with said key-switch actuated bypass valve. In a further embodiment of the invention, the present variable function voting solenoid apparatus can be used to partially initiate the safety action to provide diagnostic information on the systems capability to achieve the safety action.

### BRIEF DESCRIPTION OF THE DRAWINGS

FIG. 1 is a schematic representation of one aspect of the present invention; and

FIG. 2 is a truth table summarizing operation of the plurality of pressure switches according to a further aspect of the invention.

### DETAILED DESCRIPTION OF THE INVENTION

Those of skill in the pertinent arts do not know the use of dual solenoid-operated valve configurations for air to move fail last position process valves actuators. When these process valves employ pneumatically actuated air to move fail last position actuators, applying pressure to one side of the actuator while venting pressure on the other side of the actuator will move the valve to the open or closed position. The enhanced dual configuration described below is intended to provide a new and useful hybrid solution wherein both high safety availability and high plant system reliability are maintained. The overall assembly, hereinafter collectively referred to as the “package”, employs two solenoid-operated valves functioning in cooperative association with a plurality of pressure switches.

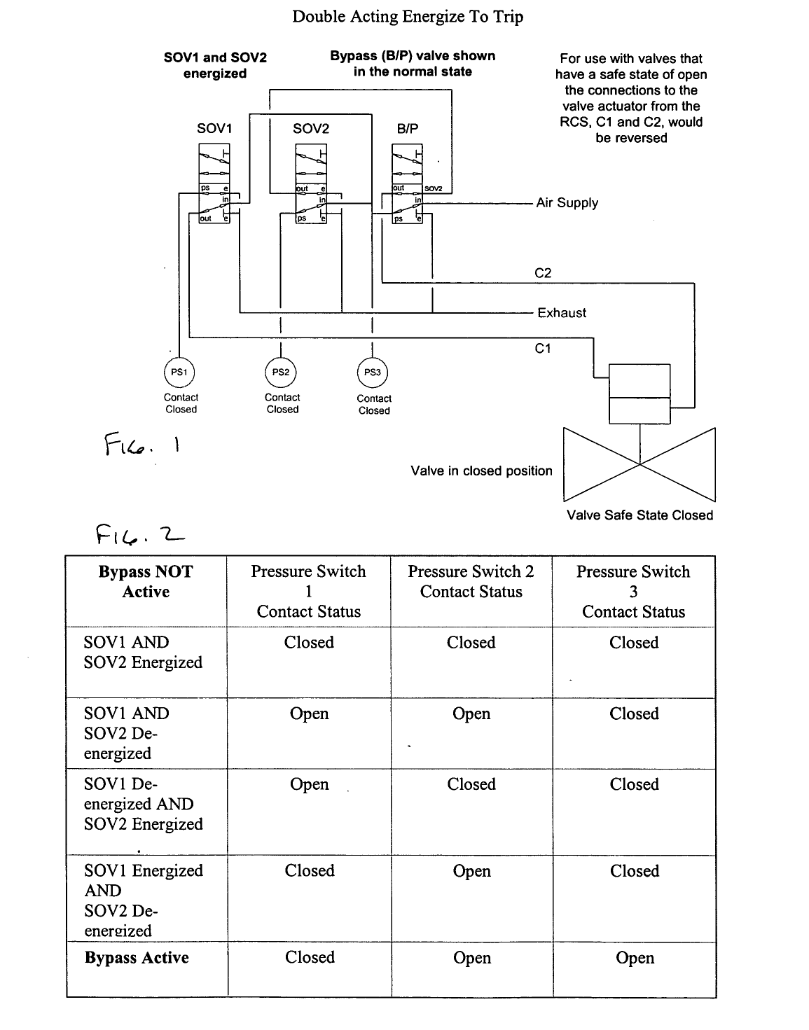

For example, and referring now to attached FIG. 1, a schematic representation of a variable voting solenoid-operated valve apparatus according to one aspect of the present invention is provided wherein a steel apparatus enclosure 10 houses a first solenoid-operated valve 1 and a second solenoid-operated valve 2; a switch actuated bypass valve 3; and a plurality of pressure switches PS1, PS2 and PS3, including a first pressure switch PS1 in fluid communication with first solenoid-operated valve 1, a second pressure switch PS2 in fluid communication with second solenoid-operated valve 2, and a third pressure switch PS3 in fluid communication with switch actuated bypass valve 3. According to a further aspect of the invention, the solenoid-operated valve package is controlled using a known logic.

With the 2oo2-D solenoid-operated valve, a plant can realize improved safety availability since the package can be tested or maintained without being bypassed prior to initiation of the testing. During normal operations, each of solenoid-operated valves 1 and 2 are energized by electromotive force provided by means of the logic control system or processor (not shown). In the energized state the solenoid operated valves direct supply air to Outlet 1 and Outlet 2 is vented to atmosphere and the contact for pressure switch PS1 is closed, the contact for PS2 is open, and the contact for pressure switch PS3 is closed. When an unsafe condition is detected and a safety action initiated (such as venting or isolation of the fluid), the process valve is actuated when both of solenoid-operated valves 1 and 2 are immediately de-energized, thereby transferring the pneumatic supply pressure to Outlet 2 and venting Outlet 1 to atmosphere and the contact for pressure switch PS1 is open, the contact for PS2 is closed, and the contact for pressure switch PS3 is closed. In one embodiment of the invention, transfer of the pneumatic source is facilitated by means of a manifold (also not shown).

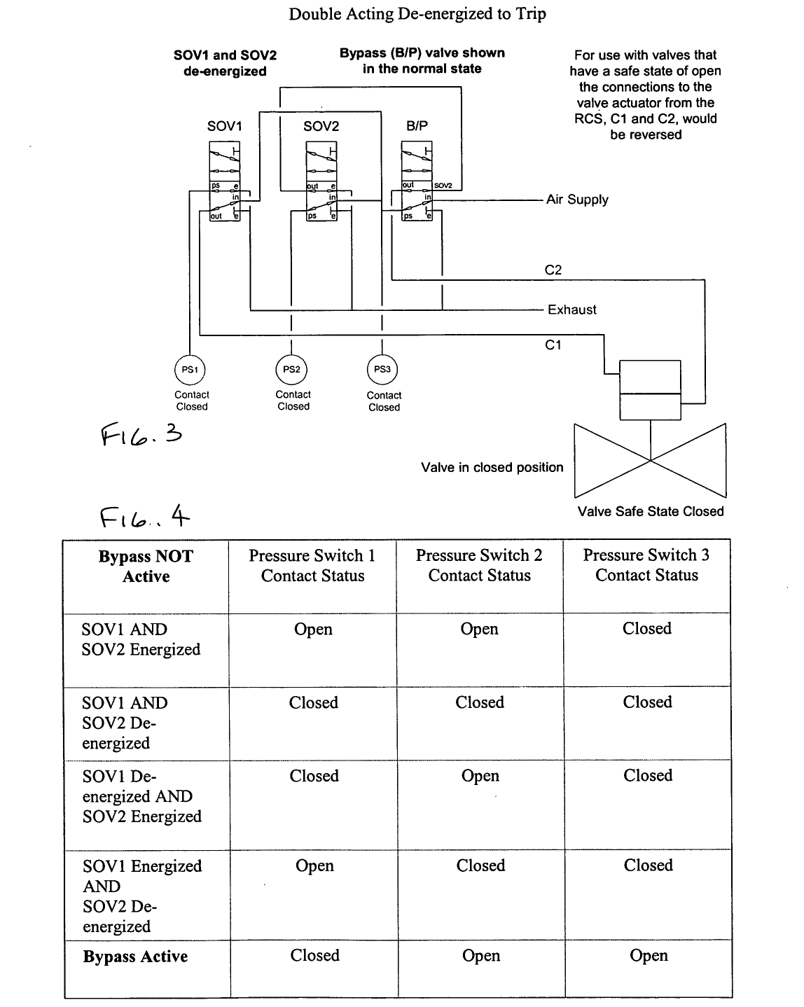

For a test sequence, solenoid-operated valve 1 is de-energized and the open state of pressure switch PS1 is confirmed by the logic control system. Then, solenoid-operated valve 1 is re-energized and the closed state of pressure switch PS1 is confirmed. Next, solenoid-operated valve 2 is de-energized and the closed state of pressure switch PS2 is confirmed. Finally, solenoid-operated valve 2 is re-energized and the open state of pressure switch PS2 is confirmed. Completion of this routine renders an accurate testing of each of the solenoid-operated valves 1 and 2 by means of their respective pressure switches without requiring bypassing of the package. A truth table summarizing each of the possible operational states of pressure switches PS1, PS2 and PS3 in the 2oo2-D configuration is provided in FIG. 2.

It should be noted that unlike the single solenoid valve configuration requiring the solenoid valve to be bypassed in order to test without disruption of the process at no time during the testing or fault detection cycle is the safety availability of the 2oo2-D package compromised. To the contrary, when a safety action such as a venting or isolation of the process fluid is required, the logic control system or processor can immediately de-energize both of solenoid-operated valves 1 and 2 and actuate the process valve, thereby initiating either the venting or isolation action.

ed.

A switch-actuated bypass valve is also provided in the package, and may include, for example, a key switch for secured manual operation. The bypass function is provided to allow maintenance on the package without interruption of the plant system. This aspect of the invention includes a bypass valve 3 which routes the pneumatic supply directly to one side of the process valve actuator while venting pressure on the other side of the actuator. The state of bypass valve 3 is detected by pressure switch PS3. When bypass valve 3 is moved or set in the bypass position, pressure switch PS3 opens and indicates to the logic control system or processor that the package is in bypass mode. Such bypassing is required only for maintenance, so loss of access to the safety action is minimized.

The 2oo2-D operational modes described above uniquely provide improved, variable functionality and greater operator flexibility for air to move fail last position valves than any other known solenoid-operated valve configuration. The package's superior testing and maintenance characteristics and fault detection capabilities provide maximum safety availability while maintaining high plant system reliability.

When the operator of the invention desires diagnostic information related to the performance of the safety action, a partial movement of the process valve can be executed to prove the process valve is capable of actuating to the safe state.

With the 2oo2-D configuration, the safety action test is performed by de-energizing solenoid-operated valve 1 and 2 for a pre-determined time period. At the conclusion of the pre-determined time period, both solenoid-operated valve 1 and solenoid-operated valve 2 are energized to prevent undesired modification or disruption of the plant process system being monitored, while providing diagnostic information on the safety action. The test routine of the safety action is completed when the logic control system returns solenoid-operated valve 1 and solenoid-operated valve 2 to the energized state.

The foregoing detailed description of the invention is intended primarily for illustrative purposes, and is not intended to include all possible aspects of the present invention. Moreover, while the invention has been shown and described with respect to an exemplary embodiment, those of skill in the pertinent arts should appreciate that the foregoing detailed description, and various other modifications, omissions and additions, so long as in the general form and detail thereof, may be made without departing from either the spirit or scope of the present invention. Having thus described the invention,

1. A variable function voting solenoid-operated valve apparatus useful for testing and controlling industrial process systems, the apparatus comprising:
a first solenoid-operated valve and a second solenoid-operated valve;
a bypass valve; and
a plurality of pressure sensors, including a first pressure sensor in fluid communication with said first solenoid-operated valve, a second pressure sensor in fluid communication with said second solenoid-operated valve, and a third pressure sensor in fluid communication with said bypass valve.

2. The variable function voting solenoid-operated valve apparatus of claim 1, wherein when said apparatus is operating in a 2 out of 2 with high diagnostics mode, testing of said apparatus may be performed thereon without bypassing said apparatus prior to initiation of testing.

3. The variable function voting solenoid-operated valve apparatus of claim 1, wherein said first solenoid-operated valve and said second solenoid-operated valve are electrically operated and direct a pneumatic supply to one side of the process valve actuator while directing the other side of the process valve actuator to atmospheric vent.

4. The variable function voting solenoid-operated valve apparatus of claim 3, wherein said first solenoid-operated valve and said second solenoid-operated valve are electrically operated and will direct dry instrument air.

5. The variable function voting solenoid-operated valve apparatus of claim 3, wherein said first solenoid-operated valve and said second solenoid-operated valve are electrically operated and direct dry instrument air filtered to around a three micron level.

6. The variable function voting solenoid-operated valve apparatus of claim 3, wherein said first solenoid-operated valve and said second solenoid-operated valve are electrically operated and direct any plant pneumatic supply.

7. The variable function voting solenoid-operated valve apparatus of claim 1, wherein said bypass valve is actuated by a switching device.

8. The variable function voting solenoid-operated valve apparatus of claim 7, wherein said switching device comprises a key switch.

9. The variable function voting solenoid-operated valve apparatus of claim 1, wherein said apparatus further comprises a manifold.

10. The variable function voting solenoid-operated valve apparatus of claim 9, wherein said manifold is comprised of aluminum.

11. The variable function voting solenoid-operated valve apparatus of claim 9, wherein said manifold is comprised of anodized aluminum.

12. The variable function voting solenoid-operated valve apparatus of claim 9, wherein said manifold is comprised of composite material.

13. The variable function voting solenoid-operated valve apparatus of claim 9, wherein said manifold is comprised of steel.

14. The variable function voting solenoid-operated valve apparatus of claim 1, wherein said apparatus further comprises an enclosed housing.

15. The variable function voting solenoid-operated valve apparatus of claim 14, wherein said apparatus further comprises an enclosed steel housing.

16. The variable function voting solenoid-operated valve apparatus of claim 14, wherein said apparatus further comprises an enclosed composite material housing.

17. A variable function voting solenoid-operated valve apparatus useful for testing and controlling industrial process systems, the apparatus comprising:
a first solenoid-operated valve and a second solenoid-operated valve;
a switch actuated bypass valve;
a valve manifold, wherein said first and second solenoid-operated valves and said switch actuated bypass valve are joined by said valve manifold;
a plurality of pressure sensors, including a first pressure sensor in fluid communication with said first solenoid-operated valve, a second pressure sensor in fluid communication with said second solenoid-operated valve, and a third pressure sensor in fluid communication with said switch actuated bypass valve.

18. A method of testing a first operational mode in a variable function voting solenoid-operated valve apparatus having a first solenoid-operated valve and a second solenoid-operated valve; a bypass valve; and a plurality of pressure sensors including a first pressure sensor in fluid communication with said first solenoid-operated valve, a second pressure sensor in fluid communication with said second solenoid-operated valve, and a third pressure sensor in fluid communication with said bypass valve, the method of testing comprising:
de-energizing said first solenoid-operated valve and confirming a closed state of said first pressure sensor;
re-energizing said first solenoid-operated valve and confirming an open state of said first pressure sensor;
de-energizing said second solenoid-operated valve and confirming a closed state of said second pressure sensor; and
re-energizing said second solenoid-operated valve and confirming an open state of said second pressure sensor.

19. The method of testing a first operational mode in a variable function voting solenoid-operated valve apparatus of claim 24, wherein said variable function voting solenoid-operated valve apparatus includes:
a first solenoid-operated valve and a second solenoid-operated valve;
a switch actuated bypass valve;
an aluminum valve manifold, wherein said first and second solenoid-operated valves and said switch actuated bypass valve are joined by said aluminum valve manifold;
a plurality of pressure sensor, including a first pressure sensor in fluid communication with said first solenoid-operated valve, a second pressure sensor in fluid communication with said second solenoid-operated valve, and a third pressure sensor in fluid communication with said switch actuated bypass valve.

20. A method of testing a second operational mode in a variable function voting solenoid-operated valve apparatus having a first solenoid-operated valve and a second solenoid-operated valve; a bypass valve; and a plurality of pressure sensors including a first pressure sensor in fluid communication with said first solenoid-operated valve, a second pressure sensor in fluid communication with said second solenoid-operated valve, and a third pressure sensor in fluid communication with said bypass valve, the method of testing comprising:
confirming an open state of each of said first pressure sensor and said second pressure sensor;
de-energizing said first solenoid-operated valve and confirming a closed state of said first pressure sensor;
re-energizing said first solenoid-operated valve and confirming an open state of said first pressure sensor; and
de-energizing said second solenoid-operated valve and confirming a closed state of said second pressure sensor.

21. The method of testing a second operational mode in a variable function voting solenoid-operated valve apparatus of claim 26, wherein said variable function voting solenoid-operated valve apparatus includes:
a first solenoid-operated valve and a second solenoid-operated valve;
a switch actuated bypass valve;
an aluminum valve manifold, wherein said first and second solenoid-operated valves and said switch actuated bypass valve are joined by said aluminum valve manifold;
a plurality of pressure sensors, including a first pressure sensor in fluid communication with said first solenoid-operated valve, a second pressure sensor in fluid communication with said second solenoid-operated valve, and a third pressure sensor in fluid communication with said switch actuated bypass valve.

22. The variable function voting solenoid-operated valve apparatus of claim 21, wherein said apparatus is used to test the performance of the safety action, a partial movement of the process valve can be executed to prove the process valve is capable of actuating to the safe state, without undesired modification or disruption of the plant process system being monitored, while providing diagnostic information on the safety action.
